(19) United States
(12) Patent Application Publication
(10) Pub. No.: US 2012/0304808 A1
(43) Pub. Date: Dec. 6, 2012

(54) DYNAMIC DAMPER

(75) Inventors: Hiroyuki Amano, Susono-shi (JP); Yu Miyahara, Susono-shi (JP); Shinichiro Suenaga, Susono-shi (JP)

(73) Assignee: TOYOTA JIDOSHA KABUSHIKI KAISHA, TOYOTA-SHI (JP)

(21) Appl. No.: 13/577,991

(22) PCT Filed: Feb. 18, 2010
(86) PCT No.: PCT/JP10/52413

§ 371 Date: Aug. 9, 2012

(51) Int. Cl. F16F 15/14

(52) U.S. Cl. 74/574.2

(57) ABSTRACT

A dynamic damper for attenuating torsional vibration of a rotary member irrespective of oscillation angle of a pendulum.

The dynamic damper 1 comprises a pendulum 3 oscillated by torque pulse of the rotary member 2, and oscillation frequency of the pendulum 3 is tuned to a torque pulse frequency. In a suspending member of the pendulum, a pivot point P and an oscillation length L of the pendulum 3 are changed in accordance with an increase in an oscillation angle of the pendulum 3. Therefore, a mass of the pendulum 3 is allowed to oscillate while tracing an approximate cycloid path so that the torsional vibration of the rotary member 2 can be attenuated irrespective of oscillation angle of the pendulum 3.

### TECHNICAL FIELD

The present invention relates to a dynamic damper arranged in a rotary member to absorb or attenuate torsional vibrations of the rotary member resulting from torque pulse.

### BACKGROUND ART

In an automotive vehicle, rotary members such as a crankshaft of an engine, an input shaft of a transmission, a driveshaft etc. are subjected to torsional vibration along its axis of rotation due to vibrations of the engine. Attempts have been made to dampen the resonant torsional vibration of the rotary member with vibrations resulting from combustions in cylinders of the engine by mounting on the rotary member a dynamic damper. An example of the dynamic damper of this kind is disclosed in Japanese Patent Laid-Open No. 2002-340097, which comprises a mass arranged on an outer circumferential side of a rotational axis of a rotary member in a manner to oscillate around a rotational center thereof being parallel to the rotational shaft of the rotary member. According to the teachings of Japanese Patent Laid-Open No. 2002-340097, a natural frequency of the mass is harmonized with a torque pulse frequency of the rotary member to attenuate the torsional vibration of the rotary member.

Another example is disclosed in Japanese Patent Laid-Open No. 2004-293669. The damping device taught by Japanese Patent Laid-Open No. 2004-293669 comprises a holding member installed on an object, an oscillation member oscillated by oscillation of the object, a ball member rotatably held in the holding member while holding a portion of the oscillating member therein, and a viscous fluid filled in a clearance between the ball member and the holding member.

The dynamic damper taught by Japanese Patent Laid-Open No. 2002-340097 is a single-pendulum type dynamic damper, and the mass is oscillated around the rotational center thereof in the opposite direction to the rotational direction of the rotary member by an inertia resulting from the torsional vibration of the rotary member. FIG. 10 illustrates an oscillating motion of a simple pendulum 3 of the dynamic damper of this kind, and an angle of oscillation is represented by θ. In order to absorb the torsional vibration of the rotary member 2 by the pendulum motion, the simple pendulum 3 is designed so that the natural frequency thereof will correspond to the torque pulse frequency of the rotary member 2. Specifically, number of oscillation of the pendulum 3 per revolution is tuned to number of torque pulse of the rotary member 2 per revolution by adjusting a radius R from the rotational center 2a of the rotary member 2 to an oscillation point P of the pendulum 3, while adjusting a length L of the pendulum 3. For this purpose, natural frequency of the pendulum 3 can be calculated using the formula (1) expressed in the following.

$$\begin{matrix}[ Formula 1 ] & \\ ω = 2 π Ω \sqrt{\frac{R}{L}} \frac{1}{1 + \frac{1}{4} {sin}^{2} \frac{θ max}{2} + \frac{9}{64} {sin}^{4} \frac{θ max}{2} + …} & ( 1 )\end{matrix}$$

where ω is the natural frequency of the pendulum 3, Ω is a nominal speed of the rotary member 2, and θ is an angle of oscillation. In the formula (1), the term underlined with a wavy line in the right side represents number of oscillation of the pendulum.

Alternatively, the natural frequency ω of the pendulum 3 may also be calculated using a linear approximation method as expressed by the following expression (2).

$$\begin{matrix}[ Formula 2 ] & \\ ωo = 2 πΩ \sqrt{\frac{R}{L}} & ( 2 )\end{matrix}$$

where ω₀ is the linearly approximated natural frequency of the pendulum 3, and Ω is a nominal speed of the rotary member 2. In the formula (2), the term underlined with a wavy line in the right side represents approximated number of vibrations of the pendulum.

In case of using the formula (2), however, the angle of oscillation θ will not be considered. In this case, as shown in FIG. 11, actual number of vibrations of the pendulum 3 will deviate from designed number of vibrations with an increase in the angle of oscillation, that is, with an increase in amplitude of vibrations of the engine. Thus, the pendulum of Japanese Patent Laid-Open No. 2002-340097 is effective to quell torsional vibration of the rotary member only under the condition in that the angle of oscillation θ is narrow.

According to the teachings of Japanese Patent Laid-Open No. 2004-293669, the oscillation member is allowed to oscillate with a rotational motion around the center of the ball member so that the vibration of the object can be absorbed regardless of orientation of the vibration.

FIG. 12 illustrates a known cycloidal pendulum (also called a Huygens pendulum) schematically. As shown in FIG. 12, the oscillation point P of the pendulum 3 and the pendulum length L are varied in accordance with changes in the angle of oscillation θ. Specifically, a mass 5 is suspended between adjacent arcuate walls S of the cycloid through a flexible suspending member. Therefore, the mass 5 traces a cycloid path as a result of displacement of the oscillation point P depending on a contact length between the suspending member and the arcuate wall S. A natural frequency of the cycloidal pendulum thus structured can be expressed as the following formula (3).

$$\begin{matrix}[ Formula 3 ] & \\ ω s = 2 πΩ \sqrt{\frac{L + α - 4 α}{4 α}} & ( 3 )\end{matrix}$$

where ω₂ is the natural frequency of the pendulum 3, Ω is a nominal speed of the rotary member 2, α is a base circle radius of the cycloid path of the pendulum 3. In the formula (3), the term underlined with a wavy line in the right side represents number of vibration per revolution N of the pendulum 3.

Thus, the number of vibration per revolution N of the cycloidal pendulum can be calculated using the formula (3) without taking into consideration the angle of oscillation θ. That is, the number of vibration per revolution N is independent of the angle of oscillation θ. FIG. 13 illustrates an example of applying the cycloidal pendulum to the rotary member. In case of thus using the cycloidal pendulum as a dynamic damper 1, torsional vibration of the rotary member 2 caused by torque pulse can be attenuated even if the angle of oscillation θ is large. In this case, the flexible suspending member suspending the mass 5 may be damaged by a centrifugal force of the mass 5 resulting from rotating the rotary member 2. In addition, the mass 5 will strike against an inner wall of a housing 4 if the pendulum 3 is oscillated in a wide range, and such collision of the mass 5 will result in excessive noise. Further, costful high-precision machining is required to form the arcuate wall S which allows the pendulum 3 to trace cycloid path. Thus, improvement of the conventional dynamic dampers is required.

### DISCLOSURE OF THE INVENTION

The present invention has been conceived noting the technical problems thus far described, and its object is to provide a dynamic damper for absorbing and attenuating torsional vibration of a rotary member resulting from torque pulse, regardless of an oscillating angle of a pendulum.

The dynamic damper of the present invention is provided to achieve the above-mentioned object. For this purpose, the dynamic damper is arranged in a rotary member, and provided with a pendulum oscillated by torque pulse appearing on the rotary member. Oscillation frequency of the pendulum is tuned to a torque pulse frequency of the rotary member. According to the dynamic damper of the present invention, a pivot point and an oscillation length of the pendulum are changed in accordance with an increase in an oscillation angle of the pendulum from a neutral position at which the pendulum is situated in case the pendulum is not oscillated.

The pendulum comprises a suspending member formed by linearly connecting a plurality of linkage members in a pivotal manner through linking joints, and a mass having a predetermined weight. The pendulum further comprises a restriction means adapted to change the pivot point and the oscillation length by restricting an oscillation angle of the linkage member, in accordance with an increase in an oscillation angle of the pendulum from the neutral position. The restriction means is adapted to restrict an oscillation of the linkage member situated closer to a rotation center of the rotary member than the pivot point, while allowing an oscillation of the linkage member situated closer to the mass than the pivot point.

The linking joint of the restriction means includes a stopper adapted to restrict the oscillation angle of the linkage member connected linearly.

A length of each linkage member is elongated sequentially from the linkage member closest to the rotation center of the rotary member toward the linkage members situated closer to the mass.

The rotary member comprises a housing for accommodating the pendulum therein. According to another aspect of the present invention, the restriction means includes a plurality of protrusions erected in the housing to restrict the oscillation angle of each of the linkage members or linking joints.

According to still another aspect of the present invention, the pendulum comprises a plurality of suspending members suspended parallel to each other.

Thus, according to the present invention, the pivot point and the oscillation length of the pendulum are changed in accordance with an increase in an oscillation angle of the pendulum from the neutral position. Consequently, the mass of the pendulum is oscillated while tracing the approximate cycloid orbit. For this reason, the number of oscillation of the pendulum per revolution will not deviate significantly from the designed number of oscillation per revolution even if the pendulum is oscillated significantly so that the torsional vibration of the rotary member can be attenuated irrespective of oscillation angle of the pendulum.

As described, the restriction means is adapted to change the pivot point and the oscillation length of the pendulum by restricting an oscillation angle of the linkage member in accordance with an increase in an oscillation angle of the pendulum. Specifically, an oscillation of the linkage member situated closer to a rotation center of the rotary member than the pivot point is restricted, and an oscillation of the linkage member situated closer to the mass than the pivot point is allowed. Therefore, the mass of the pendulum is allowed to oscillate while tracing the approximate cycloid orbit in accordance with an increase in an oscillation angle of the pendulum so that torsional vibration of the rotary member can be attenuated even if the pendulum is oscillated significantly.

Specifically, the oscillation angle of each linkage member is restricted by the stopper arranged in the linking joint. That is, the pivot point and the oscillation length of the pendulum are changed by the stopper. Therefore, the mass of the pendulum is allowed to oscillate while tracing the approximate cycloid orbit so that torsional vibration of the rotary member can be attenuated irrespective of oscillation angle of the pendulum. In addition, since the oscillation range of the pendulum is thus restricted by the stopper, the mass of the pendulum will not collide into the inner wall of the damper housing so that noise can be reduced.

As also described, a length of each linkage member may be elongated sequentially from the linkage member closest to the rotation center of the rotary member toward the linkage members situated closer to the mass. In this case, the oscillation angle of each linkage member can be equalized so that the configuration of the linking joints can be uniformed. Therefore, a manufacturing cost of the linkage member can be reduced.

Alternatively, the oscillation ranges of the linkage members may also be restricted using the plurality of protrusions erected in the damper housing. That is, the pivot point and the oscillation length of the pendulum may also be changed by the protrusions. Therefore, the mass of the pendulum is allowed to oscillate while tracing the approximate cycloid orbit so that torsional vibration of the rotary member can be attenuated irrespective of oscillation angle of the pendulum. In case of thus restricting the oscillation ranges of the linkage members by the protrusions, the damper housing can be manufactured easier in comparison with a case of forming a cycloid face on the inner wall of the damper housing.

In addition to the above-explained advantages, according to the present invention, the mass of the pendulum may also be suspended using a plurality of suspending members arranged parallel to each other. In this case, the pivot point and the oscillation length of the pendulum may also be changed in accordance with an increase in the oscillation angle of the pendulum so that the mass is also allowed to oscillate while tracing the approximate cycloid path. Therefore, the torsional vibration of the rotary member may also be attenuated irrespective of oscillation angle of the pendulum.

### BRIEF DESCRIPTION OF THE DRAWINGS

FIG. 1 is a front view schematically showing the dynamic damper of the present invention arranged in the rotary member.

FIG. 2 is a side view showing the second linking joint connecting the first linkage member and the second linkage member.

FIG. 3 is a front view showing the second linking joint connecting the first linkage member and the second linkage member.

FIG. 4 is a view showing an oscillating motion of the pendulum oscillated by the torque pulse appearing on the rotary member.

FIG. 5 is a front view schematically showing a modified example of the dynamic damper shown in FIG. 1.

FIG. 6 is a view showing oscillation angles of linkage members of the dynamic damper shown in FIG. 5 oscillating while tracing the approximate cycloid orbit.

FIG. 7 is a front view schematically showing an example of suspending the mass using two suspending members.

FIG. 8 is a front view schematically showing still another example of the dynamic damper shown in FIG. 1.

FIG. 9 is a view showing an oscillating motion of the pendulum shown in FIG. 8.

FIG. 10 is a view schematically showing an oscillating motion of a conventional simple pendulum.

FIG. 11 is a graph indicating a deviation of the number of oscillation of the simple pendulum from the designed number of oscillation according to an increase in oscillation angle.

FIG. 12 is a view schematically showing an oscillating motion of the cycloid pendulum.

FIG. 13 is a view schematically showing an example of arranging the cycloid pendulum in a rotary member.

### BEST MODE FOR CARRYING OUT THE INVENTION

Next, the present invention will be explained in more detail. The present invention relates to a dynamic damper for absorbing and attenuating torsional vibration of a rotary member resulting from torque pulse. Specifically, the dynamic damper is arranged in the rotary shaft such as an engine crank shaft of a vehicle, an input shaft of a transmission, a driveshaft etc. The dynamic damper may also be arranged in a rotary member mounted on the rotary shaft to be rotated integrally therewith. A suspending member of a pendulum comprises a plurality of linkage members, and the linkage members are pivotally connected through linking joints in a linear arrangement. One of the end portions of the suspending member is attached pivotally to the rotary member, and a mass having a predetermined weight is attached integrally to the other end portion of the suspending member. The pendulum thus structured is inertially oscillated in response to torque pulse or resultant torsional vibrations in the direction opposite to the rotational direction of the rotary member thereby attenuating the torsional vibrations of the rotary member. For this purpose, the pendulum is tuned in a manner to equalize the number of vibration per revolution N thereof to the number of torque pulses per revolution of the rotary member.

The dynamic damper is provided with a restriction means adapted to restrict the pendulum motion of the linkage members. Therefore, the oscillation of the pendulum is restricted in case the oscillation angle of the pendulum is increased due to amplification of the torsional vibration of the rotary member. Consequently, an oscillation point of the pendulum and an oscillatable length of the linkage members are changed so that the mass is oscillated in a manner to trace an approximate cycloid orbit. The natural frequency of the pendulum of the present invention thus structured can be calculated using the above explained formula (3).

Thus, the dynamic damper according to the present invention is adapted to oscillate the mass of the pendulum in a manner to trace the approximate cycloid path by changing the pivot point of the pendulum and the oscillatable length of the linkage members. For this purpose, a stopper face may be formed on one of the end portion of the linkage member in a manner to restrict the oscillation angle of the adjacent linkage member connected therewith. Alternatively, it is also possible to restrict the oscillation range of the pendulum by arranging a plurality of the stopper members in a damper housing on both sides of the suspending member.

In case of restricting the oscillation angle of the suspending member by the stopper face, the stopper face is formed on one of the end portions of each linkage member in a manner to restrict the oscillation angle of the adjacent linkage member connected thereto, and the oscillatable angle of the linkage member is increased sequentially from the radially innermost linkage member to the radially outermost linkage member. Meanwhile, in case of restricting the oscillation range of the linkage members by the protrusions, the stopper members are arranged in the housing on both sides of the linkage array in a manner to restrict the oscillatable angle of the innermost linkage member to the narrowest angle in the linkage array, while increasing the oscillatable angle of the linkage members sequentially toward the outermost linkage member. Thus, the stopper face is adapted to restrict the oscillation angle of the adjacent linkage member, and the protrusions are adapted to restrict the oscillation range of the linkage array. Therefore, the pendulum is allowed to oscillate while tracing the approximate cycloid orbit at desired frequency.

In addition, in case of restricting the oscillation range of the suspending member by the stopper face, the oscillation angles of each linkage member can be equalized by increasing lengths of the linkage members sequentially from the radially innermost linkage member toward the radially outermost linkage member. In this case, the pivot point of the suspending member and the oscillatable length of the linkage members are also changed in response to the torsional vibration so that the mass of the pendulum is allowed to oscillate in a manner to trace the approximate cycloid orbit. A curvature of the cycloid orbit is increased in accordance with an increase in the oscillation angle of the pendulum. However, in addition to the above-explained advantage, configurations of the linking joints of linkage members can be equalized in this case.

Thus, according to the dynamic damper of the present invention, the pivot point of the suspending member and the oscillatable length of the linkage members are changed in accordance with the change in the oscillation angle of the pendulum. For this purpose, oscillatable angle of each linkage member or ostillatable range of the suspending member is restricted. Therefore, the mass of the pendulum is allowed to oscillate while tracing the approximate cycloid path so that the actual oscillation frequency of the pendulum will not deviate significantly from the designed oscillation frequency. For this reason, the torsional vibration of the rotary member resulting from torque pulse can be attenuated even if the oscillation angle of the pendulum is increased.

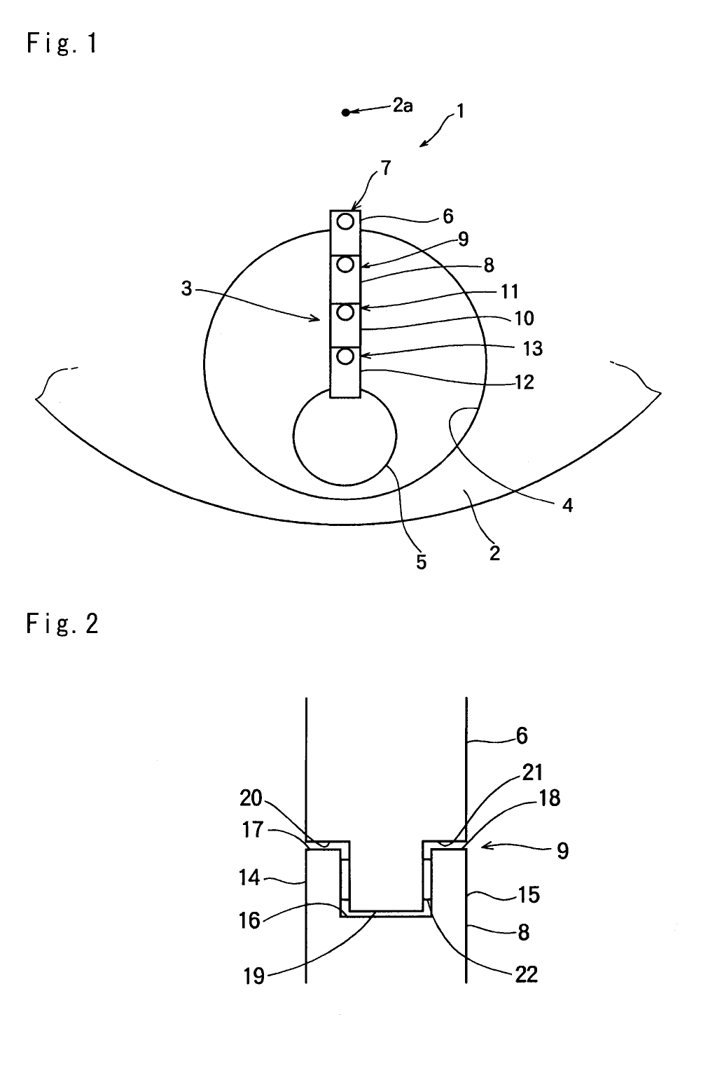

FIG. 1 is a front view schematically showing an example of applying the dynamic damper of the present invention to the rotary member. As seen in FIG. 1, a hollow annular damper housing 4 is formed in the vicinity of an outer circumferential edge of the rotary member 2, and the pendulum 3 is hosed therein. The pendulum 3 comprises a suspending member formed by connecting a plurality of linkage members in a pivotal manner through linking joints, and a mass 5 having a predetermined weight is attached to an end portion of the outermost linkage member. In order to absorb torsional vibration of the rotary member 2, number of oscillation per revolution N of the pendulum 3 is tuned to number of torque pulse pre revolution of the rotary member 2. For example, the linkage members and the mass 5 are made of metal material having predetermined rigidity and a weight.

Structure of the pendulum 3 will be explained in more detail. As shown in FIG. 1, a first linkage member 6 is attached pivotally to the rotary member 2 through a first linking joint 7 at one of its end portions. The other end portion of the first linkage member 6 is connected pivotally with one of the end portions of a second linkage member 8 through a second linking joint 9. Also, the other end portion of the second linkage member 8 is connected pivotally with one of the end portions of a third linkage member 10 through a third linking joint 11. Likewise, the other end portion of the third linkage member 10 is connected pivotally with one of the end portions of a fourth linkage member 12 through a fourth linking joint 13. Further, the mass 5 is attached integrally to the other end portion of the fourth linkage member 12. Those linking joints 7, 9, 11 and 13 are arranged individually on the end portions of the linkage members 6, 8, 10 and 12 close to the rotational center 2a of the rotary member 2.

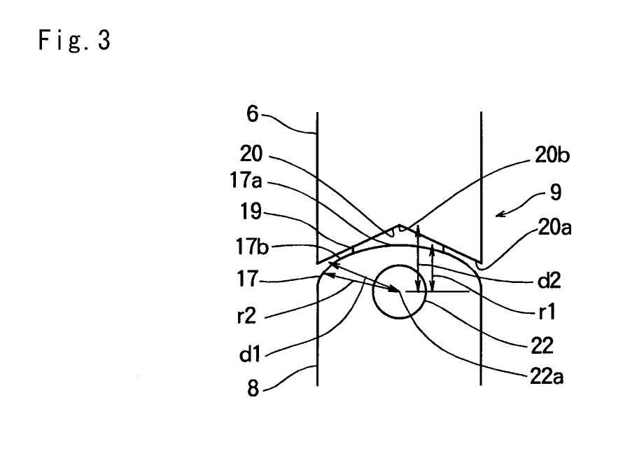

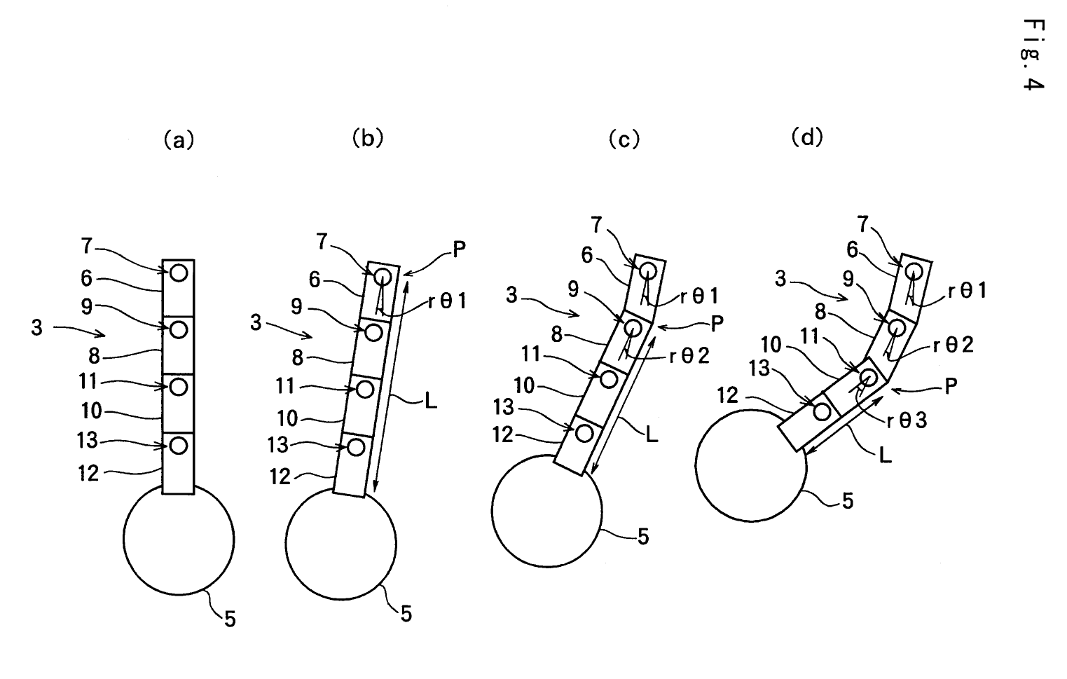

FIG. 2 is a side view showing a structure of the second linking joint 9 connecting the first linkage member 6 and the second linkage member 8, and FIG. 3 is a front view showing the structure of the second linking joint 9 connecting the first linkage member 6 and the second linkage member 8. As shown in FIGS. 2 and 3, flange portions 14 and 15 protrude radially inwardly from one of the end portions of the second linkage member 8, and a recess 16 is created between the flanges 14 and 15. As shown in FIG. 3, round faces 17 and 18 are formed at each leading end of the flange portions 14 and 15 of the second linkage member 8 to be opposed to the first linkage member 6. Meanwhile, a pair of stopper faces 20 and 21 is formed on the other end portion of the first linkage member 6 to be opposed individually to the round faces 17 and 18, and a protrusion 19 protrudes radially outwardly from between the stopper faces 20 and 21 to be inserted into the recess 16. Therefore, the first linkage member 6 can be connected pivotally with the second linkage member 8 by inserting the protrusion 19 into the recess 16 and inserting a pin 22 into the linking joint 9. Thus, the second linking joint 9 is a trunnion joint using a pin as a rotation axis.

As described, the dynamic damper 1 is provided with the restriction means adapted to oscillate the mass 5 along the approximate cycloid orbit by restricting the oscillating motion of the suspending member. Specifically, in the dynamic damper shown in FIG. 1, each linkage member 6, 8, 10 and 12 is provided with a stopper face functioning as the restriction means which is adapted to restrict oscillatable angle of those linkage members. As illustrated in FIG. 3, the second linkage member 8 is adapted to rotate around the pin 22, and the round face 17 comprises an intermediate portion 17a having a smaller curvature and a rounded corner 17b having a larger curvature. A rotation radius r1 between the rotation center 22a of the pin 22 and the intermediate portion 17a is shorter than a rotation radius r2 between the rotation center 22a and the rounded corner 17b. Meanwhile, the above-mentioned stopper face 20 is formed into V-shape. Accordingly, a distance d1 between the rotation center 22a and a stopper end 20a of the stopper face 20 is longer than the rotation radius r2 of the rounded corner 17b of the round face 17 (d1>r2), a distance d2 between the rotation center 22a and a bottom 20b of the stopper face 20 is longer than the rotation radius r1 between the rotation center 22a and the intermediate portion 17a of the rounded face 17, (d2>r1), and the distance d2 is shorter than the rotation radius r2 (d2<r2). Therefore, if the second linkage member 8 is rotated around the second linking joint 9 at a predetermined angle, the rounded corner 17b of the round face 17 is stopped by the stopper face 20 of the first linkage member 6 somewhere between the stopper end 20a and the bottom 20b. Thus, the stopper face and the round face thus formed at the linking joint correspond to the restriction means of the present invention, and each linking joint 7, 9, 11 and 13 is provided with the restriction means.

Next, an action of the dynamic damper 1 of the present invention thus structured will be explained hereinafter. FIG. 4 is a view schematically showing a pendulum motion of the pendulum 3 oscillated by the torque pulse of the rotary member 2. When the rotary member 2 in which the dynamic damper 1 is arranged is started to be rotated, a centrifugal force is applied to the pendulum 3 arranged in the damper housing 4. The centrifugal force thus applied to the pendulum 3 is increased in accordance with an increase in rotational speed of the rotary member 2. In case the centrifugal force acting on the pendulum 3 exceeds the gravitational force acting on the pendulum 3, the mass 5 of pendulum 3 is centrifugally pulled radially outside of the rotary member 2. FIG. 4 (a) illustrate a posture of the pendulum 3 under the condition in which the rotary member 2 is rotated at a constant speed, that is, the torque pulse does not appear on the rotary member 2. In this case, the pendulum 3 is situated at a neutral position as shown in FIG. 4 (a).

When the rotational speed of the rotary member 2 is fluctuated, or when the torque pulse appears on the rotary member 2, the pendulum 3 starts being oscillated. In this situation, as illustrated in FIG. 4 (b), the pendulum 3 is oscillated around the first linking joint 7 closest to the rotational center 2a of the rotary member 2. That is, the first linking joint 7 serves as a pivot point P in the beginning of the oscillation, and the first linkage member 6 is allowed to oscillate within oscillation angle rθ1 defined by the restriction means of the first linking joint 7. In case the pendulum 3 is oscillating around the first linking joint 7 within the angle rθ1, the pendulum 3 is counteracting the torsional vibration of the rotary member 2 in the vibration frequency identical to the oscillation frequency of the pendulum 3 thus oscillating within the angle rθ1.

In case the oscillation angle θ of the pendulum 3 exceeds the angle rθ1, the oscillation angle of the first linkage member 6 is restricted to the angle rθ1 by the restriction means of the first linking joint 7. As a result, the pivot point P of the pendulum 3 is moved to the second linking joint 9 as illustrated in FIG. 4(c), and the oscillation angle of the second linkage member 8 is restricted within oscillation angle rθ2 defined by the restriction means of the second linking joint 9. That is, the pendulum 3 oscillates within the total angle of rθ1 and rθ2 in this situation. In case the pendulum 3 is thus oscillating within the total angle of rθ1 and rθ2, the pendulum 3 is counteracting the torsional vibration of the rotary member 2 in the vibration frequency identical to the oscillation frequency of the pendulum 3 thus oscillating within the total angle of rθ1 and rθ2.

In case the oscillation angle θ of the pendulum 3 exceeds the total angle of rθ1 and rθ2, the oscillation angle of the second linkage member 8 is restricted to the angle rθ2 by the restriction means of the second linking joint 9. As a result, the pivot point P of the pendulum 3 is moved to the third linking joint 11 as illustrated in FIG. 4(d), and the oscillation angle of the third linkage member 10 is restricted within the oscillation angle rθ3 defined by the restriction means of the third linking joint 11. That is, the pendulum 3 oscillates within the total angle of rθ1, rθ2 and rθ3 in this situation. In case the pendulum 3 is thus oscillating within the total angle of rθ1, rθ2 and rθ3, the pendulum 3 is counteracting the torsional vibration of the rotary member 2 in the vibration frequency identical to the oscillation frequency of the pendulum 3 thus oscillating within the total angle of rθ1, rθ2 and rθ3.

Thus, according to this example, the pivot point P of the pendulum 3 is displaced in accordance with amplitude of the torque pulse appearing on the rotary member 2, in other words, in accordance with an oscillation angle of the pendulum 3. Therefore, a distance R between the rotational center 2a of the rotary member 2 and the pivot point P, and an oscillation length L of the pendulum 3 are changed in accordance with such displacement of the pivot point P. For this reason, the mass 5 of the pendulum 3 is allowed to oscillate while tracing the approximate cycloid path.

Thus, the pivot point P of the pendulum 3 is displaced by restricting the oscillatable range of each of the linkage members 6, 8, 10 and 12, and the mass 5 is allowed to trace the approximate cycloid orbit as a result of such displacement of the pivot point P. Therefore, even if the amplitude of the torsional vibration of the rotary member 2 resulting from the torque pulse of the engine is large, the actual number of oscillation per revolution N of the pendulum 3 will not deviate significantly form the designed number of oscillation per revolution of the pendulum 3. That is, the torsional vibration of the rotary member 2 resulting from torque pulse can be attenuated even if the pendulum 3 is oscillated at a large angle. In other words, the torsional vibration of the rotary member 2 can be damped irrespective of the oscillation angle of the pendulum 3. As described, the linkage members 6, 8, 10 and 12 are made of rigid material such as metal. Therefore, in addition to the above-explained advantage, rigidity of suspending member of the pendulum 3 can be ensured. Moreover, since the oscillation angle of each linkage member 6, 8, 10 and 12 is restricted by the restriction means, the mass 5 will not collide into the inner face of the damper housing 4 so that collision noise can be reduced. Further, according to this example, the mass 5 of the pendulum 3 is not rolled on the inner face of the damper housing 4. Therefore, abrasion of the mass 5 and the inner face of the damper housing 4 can be prevented so that the number of oscillation of the pendulum 3 per revolution will not be varied by the frictional deterioration of the mass and housing. In other words, endurance of the pendulum can be ensured.

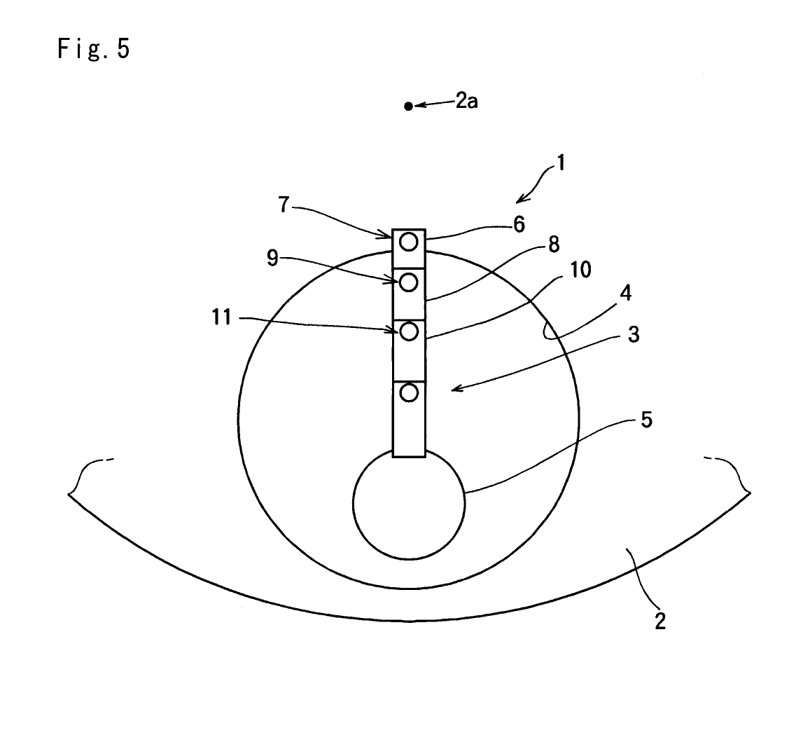

FIG. 5 is a front view showing a modification of the example shown in FIG. 1. In order to equalize the oscillation angles rθ of the linkage members, according to the example shown in FIG. 5, lengths of the linkage members are elongated sequentially from the radially innermost linkage member toward the radially outermost linkage member. As illustrated in FIG. 5, one of the end portions of the first linkage member 6 is connected with the rotary member 2, and a length of the first linkage member 6 is shortest in the linkage members of the suspending member. A length of the second linkage member 8 connected with the other end of the first linkage member 6 is longer than that of the first linkage member 8. Likewise, a length of the third linkage member 10 connected with the second linkage member 8 is longer than that of the second linkage member 8. The mass 5 is connected with the radially outer end of the outermost linkage member. According to this example, since the lengths of the linkage members are thus increased sequentially toward radially outside, the restriction angles of the restricting means can be equalized while allowing the mass 5 to oscillate along the approximate cycloid orbit.

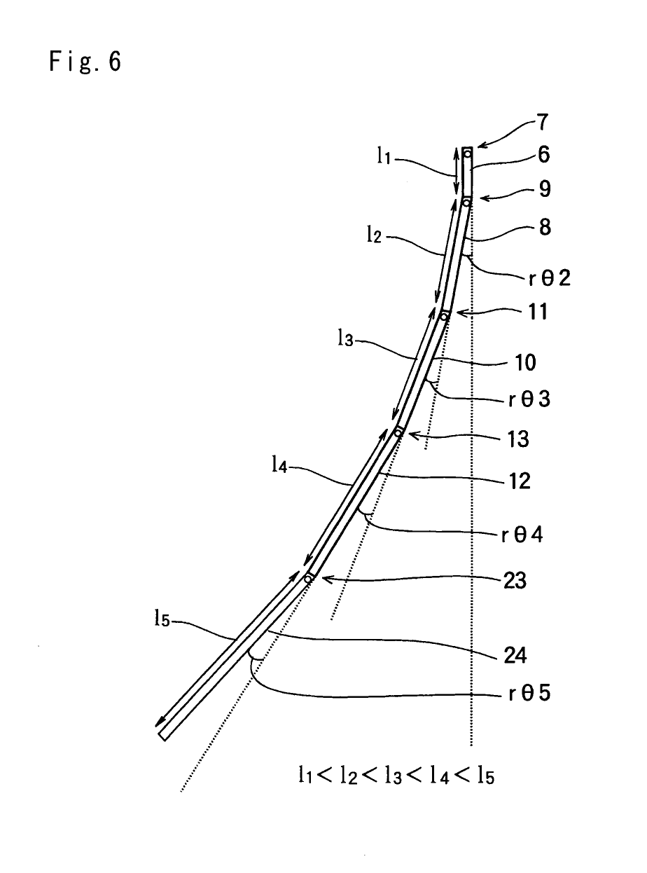

FIG. 6 illustrates an oscillating motion of the pendulum 3 shown in FIG. 5. As shown in FIG. 6, the oscillation range of the linkage members from the neutral line is increased sequentially from the radially innermost linkage member toward the radially outermost linkage member. Therefore, the mass 5 of the pendulum 5 is also allowed to oscillate while tracing the cycloid orbit in this example. Specifically, the length l1 of the first linkage member connected with the rotary member 2 is shortest in the suspending member, and the length l5 of the fifth linkage member connected with the mass 5 is longest in the suspending member. The relations of lengths of the linkage members can be expresses as the following inequality: (l1<l2<l3<l4<l5). In the pendulum 3 thus structures, for example, the oscillation angle rθ1 of the first linkage member 6 restricted by the restriction means of the first linking joint 7 is identical to the oscillation angle rθ5 of the fifth linkage member 24 restricted by the restriction means of the fifth linking joint 23. Thus, according to this example, the restricting angle of the restriction means of each linking joint can be equalized so that the oscillation angles of the linkage members 6, 8, 10, 12 and 24 restricted by the restriction means can be equalized.

According to the dynamic damper shown in FIGS. 5 and 6, therefore, configuration of the elements of the pendulum 3 can be simplified in comparison with the example shown in FIG. 1. According to this example, the pivot point P of the pendulum 3 is also displaced in accordance with amplitude of the torque pulse appearing on the rotary member 2. Therefore, the distance R between the rotational center 2a of the rotary member 2 and the pivot point P, and the oscillation length L of the pendulum 3 are changed in accordance with such displacement of the pivot point P. For this reason, the mass 5 of the pendulum 3 is allowed to oscillate while tracing the approximate cycloid path so that the torsional vibration of the rotary member 2 resulting from torque pulse can be attenuated irrespective of the oscillation angle θ of the pendulum 3. In addition to the above-explained advantages, according to this example, a configuration of each restriction means of the linking joints can be equalized. Therefore, a labor hour and a cost for manufacturing the linkage members can be reduced in comparison with those of the example shown in FIG. 1.

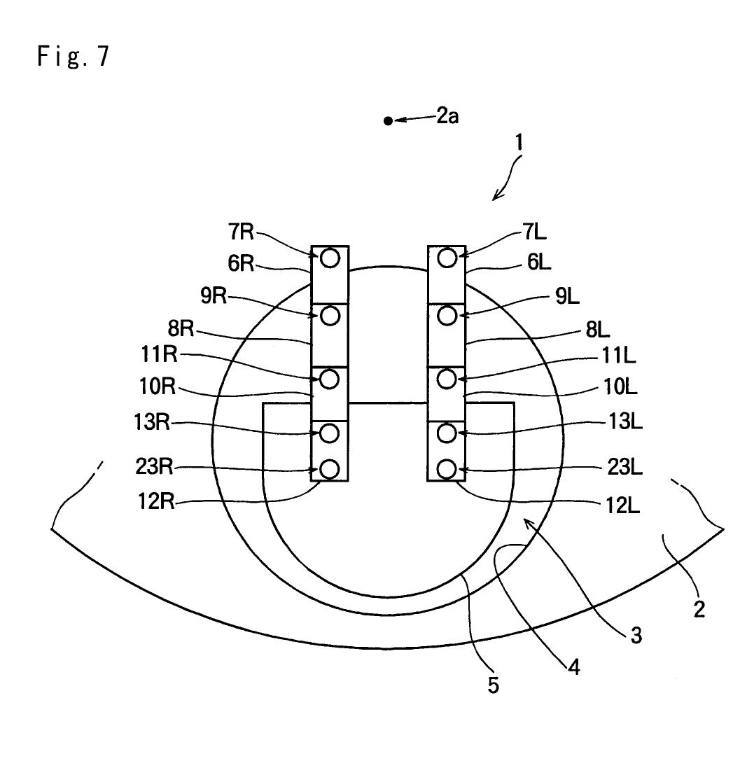

FIG. 7 illustrates an example of suspending the mass 5 using a pair of suspending members. As shown in FIG. 7, in the dynamic damper 1, the mass 5 is suspended from the rotary member 2 through a pair of the suspending members in a manner to apply weight of the mass 5 equally to those suspending members. For example, in the suspending member of the right side, one of the end portions of the first linkage member 6R is attached to the rotary member 2 through the first linking joint 7R. The other end portion of the first linkage member 6R is connected with one of the end portions of the second linkage member 8R through the second linking joint 9R. Also, the other end portion of the second linkage member 8R is connected with one of the end portions of the third linkage member 10R through the third linking joint 11R. Likewise, the other end portion of the third linkage member 10R is connected with one of the end portions of the fourth linkage member 12R through the fourth linking joint 13R. The other end portion of the fourth linkage member 12R is connected with the mass 5 through the fifth linking joint 23R. The suspending member of the left side also suspends the mass 5 from the rotary member 2 through the first linkage member 6L, the second linkage member 8L, the third linkage member 10L, and the fourth linkage member 12 L connected individually through the first linking joint 7L, the second linking joint 9L, the third linking joint 11L, the fourth linking joint 13L, and the fifth linking joint 23L. As the above-explained examples, the linking joints 7R, 7L, 9R, 9L, 11R, 11L, 13R, 13L, 23R and 23L are also provided individually with the restriction means for restricting the oscillation angles of the linkage members 6R, 6L, 8R, 8L, 10R, 10L, 12R, and 12L.

According to the dynamic damper shown in FIG. 7, the oscillation angles of the linkage members 6R, 6L, 8R, 8L, 10R, 10L, 12R, and 12L are restricted by the restriction means of the linking joints when the pendulum 3 is oscillated by the torque pulse of the rotary member 2. Therefore, the pivot point P of the pendulum 3 is also displaced in accordance with amplitude of the torque pulse appearing on the rotary member 2 or in accordance with the oscillation range of the pendulum 3. Consequently, each distance R between the rotational center 2a of the rotary member 2 and each pivot point P, and each oscillation length L of the suspending members are changed in accordance with such displacement of the pivot point P. For this reason, the mass 5 of the pendulum 3 is allowed to trace the approximate cycloid path so that the torsional vibration of the rotary member 2 resulting from torque pulse can be attenuated irrespective of the oscillation angle θ of the pendulum 3.

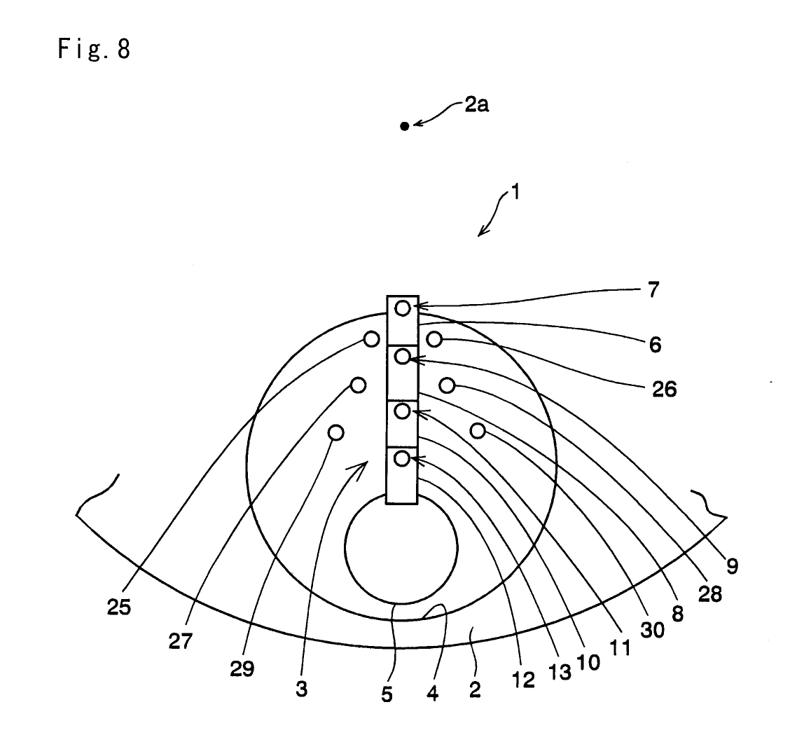

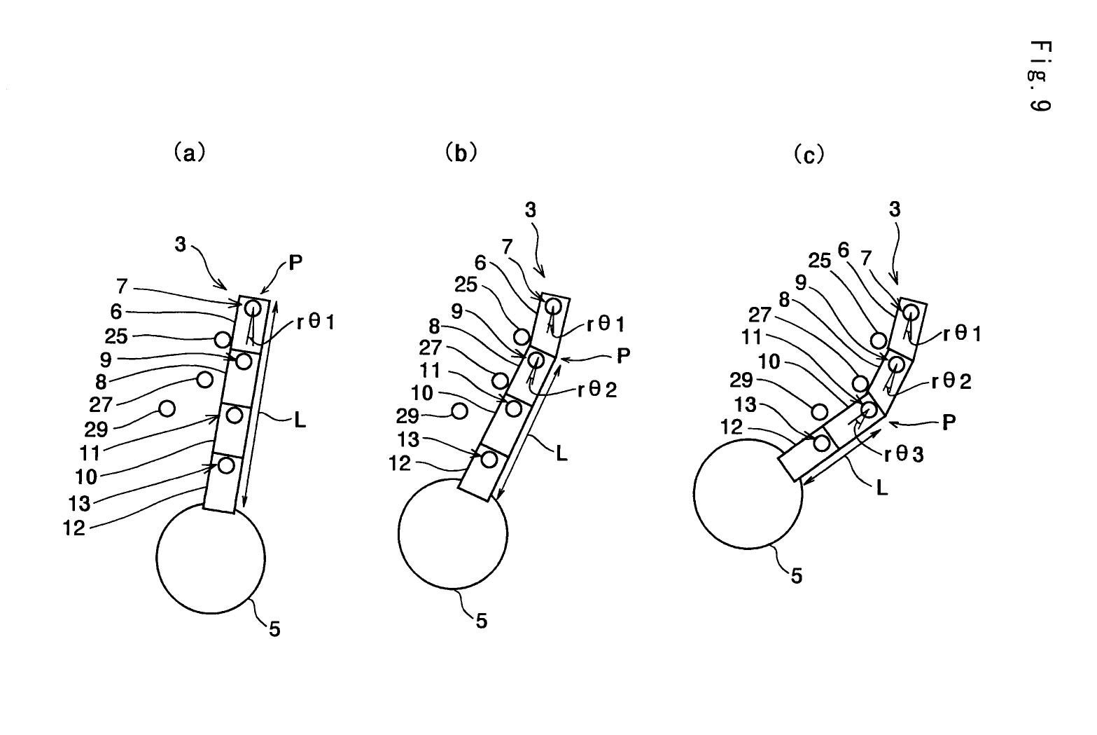

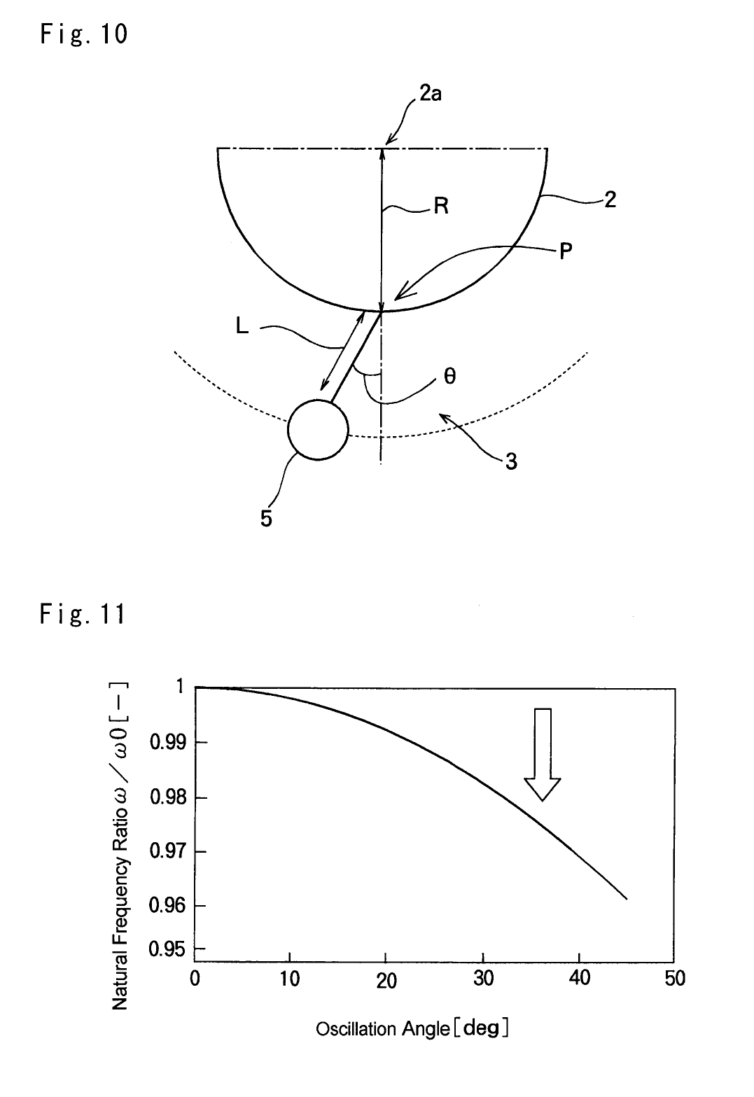

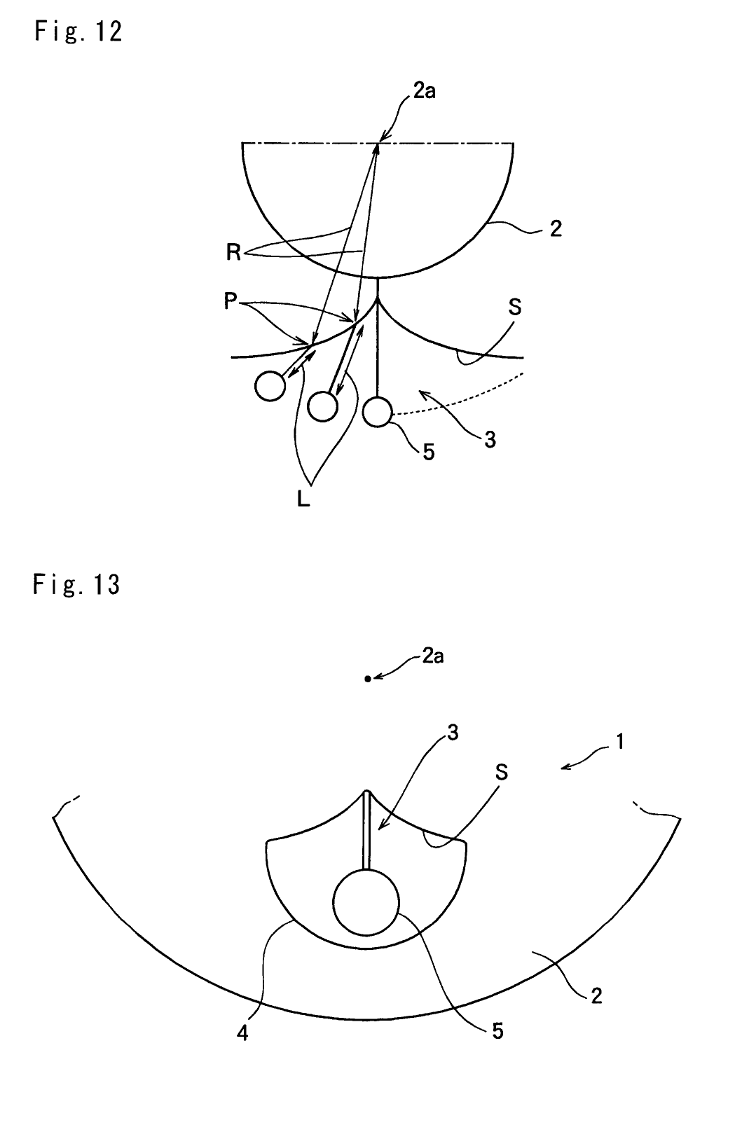

FIG. 8 is a front view showing another modification of the example shown in FIG. 1. In the dynamic damper 1 shown in FIG. 8, a plurality of protrusions 25, 26, 27, 28, 29 and 30 are erected in the damper housing 4 on both sides of the pendulum 3 for the purpose of restricting the oscillation range of the linkage members 6, 8, 10 and 12 of the pendulum 3. FIG. 8 illustrates a situation in which the pendulum 3 is situated at the neutral position. In order to restrict the oscillation range of the first linkage member 6, a first pair of protrusions 25 and 26 is erected across the first linkage member 6 at equal distances from the first linkage member 6.

The second pair of the protrusions 27 and 28 are erected across the second linkage member 8. Specifically, the second pair of the protrusions 27 and 28 is arranged on both sides of the second linkage member 8 at equal distances in radially outer side of the first pair of protrusions 25 and 26. However, the distance between the second protrusion 27 or 28 to the pendulum 3 at the neutral position is longer than that between the first linkage member 25 or 26 to the pendulum 3 at the neutral position.

Likewise, the third pair of the protrusions 29 and 30 are erected across the third linkage member 8. Specifically, the third pair of the protrusions 29 and 30 is arranged on both sides of the third linkage member 10 at equal distances in radially outer side of the second pair of protrusions 27 and 28. However, the distance between the third protrusion 29 or 30 to the pendulum 3 at the neutral position is longer than that between the second linkage member 27 or 28 to the pendulum 3 at the neutral position. Thus, the distance between each pair of protrusions across the pendulum 3 is increased sequentially from the first pairs of protrusions 25 and 26 toward the third pairs of protrusions 29 and 30, that is, from radially inner side toward radially outer side. Those protrusions 25, 26, 27, 28, 29 and 30 are extended along the rotational axis of the rotary member 2. According to this example, therefore, the restriction means is not formed on the end portion of each linkage member, and the oscillation range of the array of the linkage members 6, 8, 10 and 12 is restricted by the protrusions 25, 26, 27, 28, 29 and 30.

An action of the dynamic damper 1 thus structured will be explained hereinafter. FIG. 9 schematically illustrates an oscillating motion of the pendulum 3 shown in FIG. 8. When the torque pulse appears on the rotary member 2 in which the dynamic damper 1 shown in FIG. 8 is arranged, the pendulum 3 starts oscillating around the first linking joint 7 as illustrated in FIG. 9(a). In this situation, specifically, the first linking joint 7 serves as the pivot point P, and the oscillation angle of rθ1 of the first linkage member 6 is restricted within the first pair of protrusions 25 and 26. In case the pendulum 3 is oscillating around the first linking joint 7 within the angle rθ1, the pendulum 3 is counteracting the torsional vibration of the rotary member 2 in the vibration frequency identical to the oscillation frequency of the pendulum 3 thus oscillating within the angle rθ1.

In case the oscillation angle θ of the pendulum 3 exceeds the angle rθ1, the oscillating first linkage member 6 is stopped by the protrusion 25 or 26, and the pivot point P of the pendulum 3 is thereby moved to the second linking joint 9 as illustrated in FIG. 9(b). In this situation, the oscillation angle of the second linkage member 8 is restricted to the angle rθ2, and the pendulum 3 is allowed to oscillate within the clearance between the second pair of protrusions 27 and 28. In case the second linkage member 8 is thus oscillating within the second pair of protrusions 27 and 28, the pendulum 3 is oscillating within the total angle of rθ1 and rθ2 thereby counteracting the torsional vibration of the rotary member 2 in the vibration frequency identical to the oscillation frequency of the pendulum 3 thus oscillating within the total angle of rθ1 and rθ2.

In case the oscillation angle θ of the pendulum 3 exceeds the total angle of rθ1 and rθ2, the second linkage member 8 is stopped by the protrusion 27 or 28, and the pivot point P of the pendulum 3 is thereby moved to the third linking joint 11 as illustrated in FIG. 9(c). In this situation, the oscillation angle of the third linkage member 10 is restricted to the angle rθ3, and the pendulum 3 is allowed to oscillate within the clearance between the third pair of protrusions 29 and 30. In case the third linkage member 10 is thus oscillating within the third pair of protrusions 29 and 30, the pendulum 3 is oscillating within the total angle of rθ1, rθ2 and rθ3 thereby counteracting the torsional vibration of the rotary member 2 in the vibration frequency identical to the oscillation frequency of the pendulum 3 thus oscillating within the total angle of rθ1, rθ2 and rθ3.

Thus, according to this example, the oscillation angles of the linkage members 6, 8, 10 and 12 are restricted by the protrusions 25, 26, 27, 28, 29 and 30 in accordance with amplitude of the torque pulse appearing on the rotary member 2, in other words, in accordance with an oscillation angle of the pendulum 3. That is, the pivot point P of the pendulum 3 is displaced in accordance with an oscillation angle of the pendulum 3. Consequently, the distance R between the rotational center 2a of the rotary member 2 and the pivot point P, and the oscillation length L of the pendulum 3 are also changed in accordance with such displacement of the pivot point P. Therefore, the mass 5 of the pendulum 3 is allowed to trace the approximate cycloid path. For this reason, number of oscillation of the pendulum 3 per revolution of the rotary member 2 will not deviate significantly from the designed number of oscillation per revolution even if the pendulum 3 is oscillated widely by the torsional vibration of the rotary member 2 resulting from torque pulse. That is, the torsional vibration of the rotary member 2 can be attenuated irrespective of oscillation amplitude of the pendulum 3.

In case of restricting the oscillation ranges of the linkage members 6, 8, 10 and 12 by thus arranging the protrusions 25, 26, 27, 28, 29 and 30 in the damper housing 4, the damper housing 4 can be formed easily without forming cycloid arcs on the inner face thereof. In addition, the mass 5 of the pendulum 3 will not be rolled on the damper housing 4. Therefore, the number of oscillation of the mass 5 will not be changed due to frictional wear of the inner wall of the damper housing 4 or the mass 5 itself. In other words, durability of the dynamic damper 1 can be ensured.

Thus, according to the present invention, the mass of the pendulum can be oscillated while tracing the approximate cycloid path by restricting the oscillation angle of each linkage member to change the pivot point of the pendulum. That is, a virtual cycloid pendulum can be provided. Therefore, the torsional vibration of the rotary member 2 can be attenuated irrespective of oscillation amplitude of the pendulum. In other words, according to the present invention, the torsional vibration of the rotary member resulting from torque pulse can be attenuated even if the pendulum is oscillated significantly.

1. A dynamic damper, which is arranged in a rotary member, comprising:
a pendulum, which is oscillated by torque pulse appearing on the rotary member, and whose oscillation frequency is tuned to a torque pulse frequency;
wherein a pivot point of the pendulum is changed in accordance with an increase in an oscillation angle of the pendulum from a neutral position at which the pendulum is situated in case the pendulum is not oscillated; and
a distance between a rotational center of the rotary member and the pivot point of the pendulum, and an oscillation length of the pendulum are changed by the change in the pivot point of the pendulum.

2. The dynamic damper as claimed in claim 1, wherein the pendulum comprises:
a suspending member formed by linearly connecting a plurality of linkage members in a pivotal manner through linking joints;
a mass having a predetermined weight; and
a restriction means adapted to change the pivot point and the oscillation length by restricting an oscillation angle of the linkage member, in accordance with an increase in an oscillation angle of the pendulum from the neutral position.

3. The dynamic damper as claimed in claim 2,
wherein the restriction means includes a stopper formed in the linking joint to restrict the oscillation angle of the linkage member connected therewith.

4. The dynamic damper as claimed in claim 3,
wherein a length of each linkage member forming the suspending member is elongated sequentially from the linkage member closest to the rotation center of the rotary member toward the linkage members situated closer to the mass.

5. The dynamic damper as claimed in claim 2,
wherein the rotary member comprises a damper housing adapted to accommodate the pendulum; and
the restriction means includes a plurality of protrusions erected in the housing to restrict the oscillation range of each of the linkage members.

6. The dynamic damper as claimed in claim 1,
wherein the pendulum comprises a plurality of said suspending members suspended parallel to each other.

7. The dynamic damper as claimed in claim 3,
wherein the rotary member comprises a damper housing adapted to accommodate the pendulum; and
the restriction means includes a plurality of protrusions erected in the housing to restrict the oscillation range of each of the linkage members.

8. The dynamic damper as claimed in claim 4,
wherein the rotary member comprises a damper housing adapted to accommodate the pendulum; and
the restriction means includes a plurality of protrusions erected in the housing to restrict the oscillation range of each of the linkage members.

9. The dynamic damper as claimed in claim 2,
wherein the pendulum comprises a plurality of said suspending members suspended parallel to each other.

10. The dynamic damper as claimed in claim 3,
wherein the pendulum comprises a plurality of said suspending members suspended parallel to each other.

11. The dynamic damper as claimed in claim 4,
wherein the pendulum comprises a plurality of said suspending members suspended parallel to each other.

12. The dynamic damper as claimed in claim 5,
wherein the pendulum comprises a plurality of said suspending members suspended parallel to each other.

13. The dynamic damper as claimed in claim 7,
wherein the pendulum comprises a plurality of said suspending members suspended parallel to each other.

14. The dynamic damper as claimed in claim 8,
wherein the pendulum comprises a plurality of said suspending members suspended parallel to each other.
